(19) United States
(12) Patent Application Publication
(10) Pub. No.: US 2015/0092157 A1
(43) Pub. Date: Apr. 2, 2015

(54) Progressive Addition Lens for a Wearer

(71) Applicant: ESSILOR INTERNATIONAL (COMPAGNIE GENERALE D'OPTIQUE), Charenton Le Pont (FR)

(72) Inventors: Mélanie Tessieres, Charenton Le Pont (FR); Bruno Fermigier, Charenton Le Pont (FR); Sylvain Chene, Charenton Le Pont (FR); Wissam Mouallem, Charenton Le Pont (FR)

(73) Assignee: ESSILOR INTERNATIONAL (COMPAGINE GENERALE D'OPTIQUE), Charenton Le Pont (FR)

(21) Appl. No.: 14/387,513

(22) PCT Filed: Mar. 25, 2013
(86) PCT No.: PCT/EP2013/056315

§ 371 Date: Sep. 23, 2014

(30) Foreign Application Priority Data
Mar. 23, 2012 (EP) 12305342.3

(51) Int. Cl. G02C 7/06; G02C 7/02

(52) U.S. Cl. CPC G02C 7/061; G02C 7/027
USPC 351/159.42; 351/159.74

(57) ABSTRACT

A progressive addition lens for a wearer, the optical lens having an addition lower by at least 0.5 diopter to the prescribed addition value of the wearer, wherein for a pupil diameter of 4 mm the modulation transfer function is greater or equal to 0.1 when measured for a spatial frequency comprised between 0 and 20 cycles per degree

### RELATED APPLICATIONS

This application is a U.S. National Phase application under 35 USC 371 of International Application PCT/EP2013/056315 filed Mar. 25, 2013.

This application claims the priority of European application No. 12305342.3 filed Mar. 23, 2012, the entire content of which is hereby incorporated by reference.

### FIELD OF THE INVENTION

The present invention relates to a progressive addition lens for a wearer, a method of determining such progressive addition lens and a manufacturing method of such progressive addition lens.

### BACKGROUND OF THE INVENTION

Progressive addition lenses have been used for many years to correct an ametropy of a wearer in a manner that is suited both to far vision and near vision. For this, the lens has optical power values that are variable along a meridian line, between a reference direction for far vision and a reference direction for near vision. The optical power values for these two reference directions are determined from a prescription which is prepared for the wearer. Usually, the prescription indicates an optical power value for far vision and an addition value. The optical power value of the lens that is appropriate to the wearer to correct his sight in near vision conditions is equal to the sum of the optical power value which is prescribed for far vision and the prescribed addition value. The lens which is supplied to the wearer is produced in such a way as to produce substantially the optical power value which is thus calculated for near vision and the optical power value which is prescribed for far vision, respectively for the two reference directions for near vision and for far vision.

It is known that a progressive addition lens exhibits, in a manner which is inherent in its principle, an unintentional astigmatism.

According to the design of the surfaces of the optical lens the unintentional astigmatism may be distributed in lateral regions of the lens, so as to interfere with the vision of the wearer as little as possible. This distribution of the unintentional astigmatism can be performed by favoring a wide channel without astigmatism, between the reference directions for the far and near visions. However, the unintentional astigmatism is then greater towards the lateral edges of the lens. Alternatively, a channel without astigmatism which is narrow makes it possible to reduce the unintentional astigmatism values in the lateral regions of the lens.

The unintentional astigmatism may cause difficulty for the wearer to adapt to new progressive addition lenses and may cause optical aberrations when using such progressive optical lenses.

Thus, there is a need for progressive addition lens that presents less unintentional astigmatism than the existing progressive optical lens.

### SUMMARY OF THE INVENTION

One object of the present invention is to provide a progressive addition lens to a wearer which has a reduced unintentional astigmatism.

In accordance with a first aspect of the invention there is provided a progressive addition lens for a wearer, the optical lens having an addition lower by at least 0.5 diopter to the prescribed addition value of the wearer, wherein for a pupil diameter of at least 4 mm the modulation transfer function differs from zero over the range of spatial frequency comprised between 0 and 20 cycles per degree.

The progressive addition lens according to an embodiment of the invention has an addition lower than the prescribed addition value.

Thus, the progressive addition lens according to the invention presents less unintentional astigmatism than a progressive addition lens that has an addition equal to the prescribe addition.

Furthermore, the progressive addition lens according to the invention presents a depth of focus greater than common progressive optical lenses. Thus, although the progressive addition lens according to the invention has an addition lower than the prescribed addition the optical effect for the wearer is close to the optical effect of a progressive addition lens having the prescribed addition.

Finally, a progressive addition lens according to the invention provides an optical effect to the wearer close to the optical effect of a common progressive addition lens but having an addition value lower than the prescribed value, the progressive addition lens according to the invention presents less unintentional astigmatism.

According to further embodiments which can be considered alone or in combination:

the modulation transfer function is measured at distances comprised between the near vision distance, for example 0.5 m and the far vision distance, for example 1000m; and/or

the pupil diameter is set to 4 mm; and/or

the addition of the optical lens is lower by at least diopter to the prescribed addition of the wearer; and/or

the modulation transfer function is greater or equal to 0.1 when measured for a spatial frequency comprised between 0 and 20 cycles per degree; and/or

the progressive addition lens comprises at least in the near vision zone a phase modulation mask configured for effecting a modulation of the light; and/or

the phase modulation mask is configured so as to provide optical power; and/or

at least one of the surfaces of the progressive addition lens comprises geometrical aberrations; and/or

the progressive addition lens comprises:
a first vision zone corresponding to the portion of the progressive addition lens having a dioptric power for a first distance vision,
a near vision zone corresponding to the portion of the progressive addition lens for near distance vision,
a intermediate corridor corresponding to the portion of the progressive addition lens providing clear vision for ranges intermediates between the first distance and the near distance,
wherein the first vision zone is a far vision zone or an intermediate vision zone.

Another aspect of the invention relates to a process implemented by computer means for determining the optical surfaces of a progressive addition lens for a wearer, the method comprising:
a prescription data providing step during which prescription data of the wearer comprising the prescribed addition are provided,
an optical function determining step during which an optical function according to the prescription data is determined, and
a surface determining step during which the surfaces of an optical lens having the previously determined optical function are determined,

wherein the optical function corresponds to an virtual progressive lens having:
a first vision zone corresponding to the portion of the progressive addition lens having the dioptric power for the first distance vision corresponding to the prescription data,
an addition between the first vision zone and the near vision smaller in absolute value than the addition of the prescription data, and
wherein for a pupil diameter of 4 mm the modulation transfer function differs from zero over the range of spatial frequency comprised between 0 and 20 cycles per degree.

According to further embodiments which can be considered alone or in combination:

during the optical function determining step, geometrical aberrations are added to the virtual progressive lens so as to increase the depth of focus in the near vision zone; and/or

the process further comprises a phase modulation mask determining step during which a phase modulation mask to be added at least in the near vision zone of optical lens so as to increase the depth of focus in the near vision zone is determined.

Another aspect of the invention relates to a manufacturing process for manufacturing a progressive addition lens using a manufacturing device comprising the steps of:

providing a lens blank,

blocking the lens blank,

surfacing the surfaces of the lens blank as determined according to the invention.

Another aspect of the invention relates to a computer program product for a data processing device, the computer program product comprising a set of instructions which, when loaded into the data processing device, causes the data processing device to perform the method according to the invention.

Another aspect of the invention relates to a computer-readable medium having computer-executable instructions to enable a computer system to perform the method according to the invention.

Unless specifically stated otherwise, as apparent from the following discussions, it is appreciated that throughout the specification discussions utilizing terms such as “computing”, “calculating”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. Embodiments of the present invention may include apparatuses for performing the operations herein. This apparatus may be specially constructed for the desired purposes, or it may comprise a general purpose computer or Digital Signal Processor (“DSP”) selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMS) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

### BRIEF DESCRIPTION OF THE DRAWINGS

Embodiments of the invention will now be described, by way of example only, and with reference to the following drawings in which:

FIGS. 1a and 1b represent optical characteristic of two distinct progressive addition lens;

FIGS. 2a to 2f compare the modulation transfer functions (MTF) of a far vision corrected eye without phase mask and of a far vision corrected eye with a phase mask according to the invention;

FIG. 3 illustrates the step of a process according to the invention;

FIG. 4 represents an non accommodating eye of a person viewing through a lens having a classical near vision zone (dashed lines) and through a near vision zone at a near vision point of a progressive addition lens according to the invention (continuous lines), showing a depth of focus;

FIG. 5 is a scheme representing how a modulation transfer function is measured (or calculated) for obtaining the curves represented in FIGS. 2a to 2f and finally, an extended depth of focus;

FIGS. 6a and 6b show a phase modulation mask for a near vision zone of a progressive addition lens according to the invention, said mask having a “snail” shape;

FIG. 7 shows a phase modulation mask for a near vision zone of a progressive addition lens according to the invention, said mask having a “concentric” shape.

### DETAILED DESCRIPTION OF THE DRAWINGS

Elements in the figures are illustrated for simplicity and clarity and have not necessarily been drawn to scale. For example, the dimensions of some of the elements in the figure may be exaggerated relative to other elements to help improve the understanding of the embodiments of the present invention. The invention may apply to all ophthalmic lenses, such as glasses for spectacles, contact lenses or intraocular lenses.

A progressive addition lens for a wearer according to the invention has an addition value lower than the prescribed addition value of the wearer.

According to an embodiment of the invention, the progressive addition lens comprises a first vision zone, a near vision zone and an intermediate corridor.

The first vision zone corresponds to the portion of the progressive addition lens having a dioptric power for a first distance vision.

According to an embodiment of the invention the first distance vision is a far distance vision. The far vision zone is the zone of the lens that surrounds the far vision point, and within which the local optical characteristics of optical power and of astigmatism of the lens are substantially identical to those at the far vision point. The far vision point is the point of a surface of a progressive addition lens through which the sight of the wearer passes when said wearer looks at infinity and where the values of the Sphere, cylinder and Axe correspond to the wearer's prescription for far vision.

According to an embodiment of the invention the first distance vision is an intermediate distance vision. The intermediate vision zone is the zone of the lens that surrounds the intermediate vision point, and within which the local optical characteristics of optical power and of astigmatism of the lens are substantially identical to those at the intermediate vision point. The intermediate vision point is the point of a surface of a progressive addition lens through which the sight of the wearer passes when said wearer looks at an intermediate distance between infinity and reading distance and where the values of the Sphere, cylinder and Axe correspond to the wearer's prescription for intermediate vision.

The near vision zone corresponds to the portion of the progressive optical lens for near distance vision. The near vision zone is the zone of the lens that surrounds the near vision point, and within which the local optical characteristics of optical power and of astigmatism of the lens are substantially identical to those of the near vision point. Near vision point is the point of a surface of a progressive addition lens through which the sight of the wearer passes when said wearer is in a reading position.

The intermediate corridor corresponds to the portion of the progressive optical lens providing clear vision for ranges intermediates between the first distance and the near distance.

According to an embodiment of the invention, the difference between the addition value of the progressive addition lens according to the invention and the prescribed addition value is greater or equal to 0.5 diopter, for example greater or equal to 1 diopter.

For example, if the ophthalmologist provides a prescription with an addition value of 2 diopters, the lens which will be made according to the invention will actually have an addition value of 1.5 diopters or less, for example of 1 diopter. Thus, the invention has no impact on the ophtalmologist's prescription.

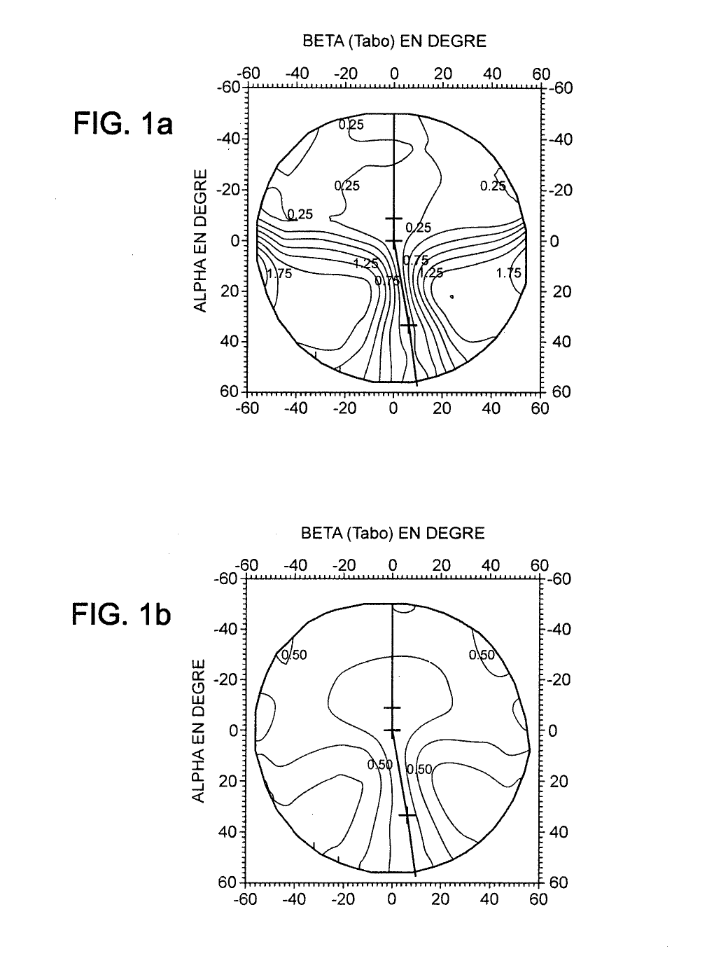

FIGS. 1a and 1b show lines of equal astigmatism, i.e. lines formed by points for which astigmatism has an identical value. The difference in astigmatism is 0.25 between two adjacent lines on FIGS. 1a and 1b.

The progressive addition lens represented on FIG. 1a has an addition value of 2 diopters and the progressive addition lens represented on FIG. 1b has an addition value of 1 diopter.

As one can see when comparing FIGS. 1a and 1b, a progressive optical lens having an addition of 2 diopters, as represented on FIG. 1a, presents much greater unintentional astigmatism than a progressive addition lens having an addition of 1 diopter as represented on FIG. 1b. Indeed, the lines of equal astigmatism are much closer on FIG. 1a than on FIG. 1b.

Thus, reducing the addition value of a progressive addition lens reduces the unintentional astigmatism.

Therefore, by providing a progressive addition lens having a addition value lower than the prescribed addition value to a wearer, the invention reduces the unintentional astigmatism of the provided progressive addition lens.

In order to compensate for the reduced value of addition, the inventors propose to provide an increase depth of focus to the lens. This increase of the depth of focus is carried out on the near vision zone of the progressive addition lens according to the invention, along the viewing direction of the wearer' passing through the near vision point.

As well known by the man skilled in the art, the depth of focus is the distance over which a clear image may be obtained with a limited accommodation effort of the wearer.

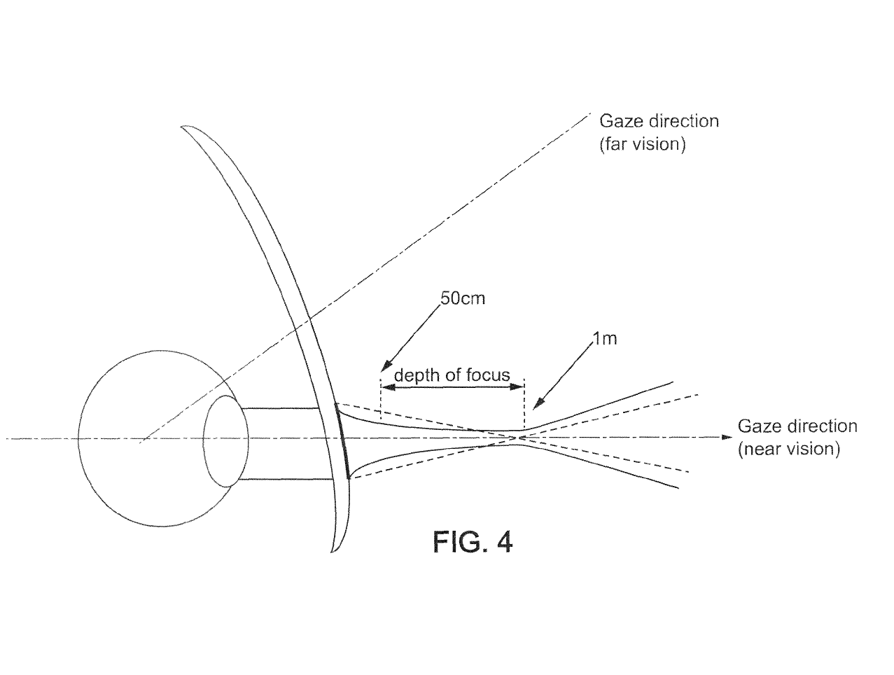

In FIG. 4, we may see the focus point for a classical progressive lens (dashed lines). In that case, the depth of focus is quite weak around the focus point. In this FIG. 4, we may also see the depth of focus obtained with a progressive addition lens according to the invention (continuous lines). By comparing the lines between them, we can observe that depth of focus is much more important with the progressive addition lens according to the invention. For that reason, we will talk about an extended depth of focus hereinafter, regarding the progressive addition lens according to the invention.

Consequently, an extended depth of focus provides an extended distance over which a clear image may be obtained with a limited accommodation effort of the wearer.

As shown in FIG. 4, in a first non limited example, in the frame of the invention, the extended depth of focus may be of 0.33 m (1−0.66 m) so that the zone defined by this extended length of focus begins at a distance of 0.66 m from the near vision point.

According to an embodiment of the invention, the progressive addition lens is arranged so that the modulation transfer function (MTF) measured for spatial frequency comprised between 0 and 20 cycles per degree and with a pupil diameter of 4 mm is different from zero, for example greater than or equal to 0.1

The modulation transfer function can be determined by any known process. For example, the modulation transfer function can be measured by using the image of a grid pattern of alternate black and white lines trough the progressive addition lens.

The increase depth of focus can be obtained by any known method.

Practically, the relevant MTF and consequently, the relevant extended depth of focus described here above may be obtained by adding, at least in the near vision zone, a phase modulation mask, or by foreseeing geometric aberrations on at least one of the surfaces of the near vision zone or by a mixture of these two techniques.

Thus, according to an embodiment of the invention, the progressive addition lens comprises at least in the near vision zone a phase modulation mask configured for modifying the phase of the light. As well known by one skilled in the art, the function of a phase modulation mask is to modify the phase of the light. The phase modulation mask may be configured so as to provide optical power.

In particular, it should be noted that the phase modulation mask brings about modification of the depth of focus as shown in FIG. 4.

According to an embodiment of the invention, at least one of the surfaces of the progressive addition lens comprises geometrical aberrations. Such geometrical aberrations are determined so as to increase the depth of focus of the progressive addition lens. Practically, such geometrical aberrations are carried out on at least one surfaces of the near vision zone to increase the depth of focus, as shown in FIG. 4.

Methods for determining the geometrical aberrations and/or the phase modulation mask so as to increase the depth of focus are well known of the skilled person. Such geometrical aberration can be determined using an optimization method using a cost function that maximizes the modulation transfer function (MTF) in a range of spatial frequency and for predefined viewing distances.

Among the well known optimization methods, the conjugate gradient method or the quasi-Newton methods can be used.

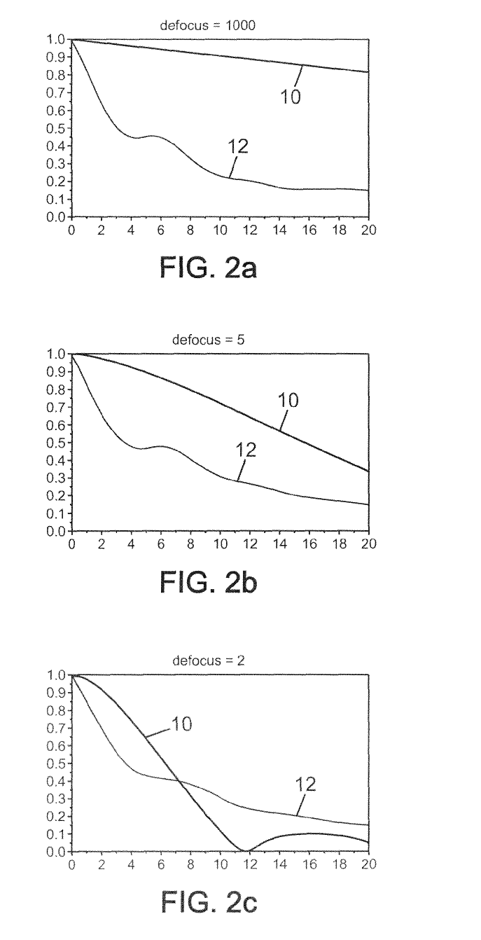

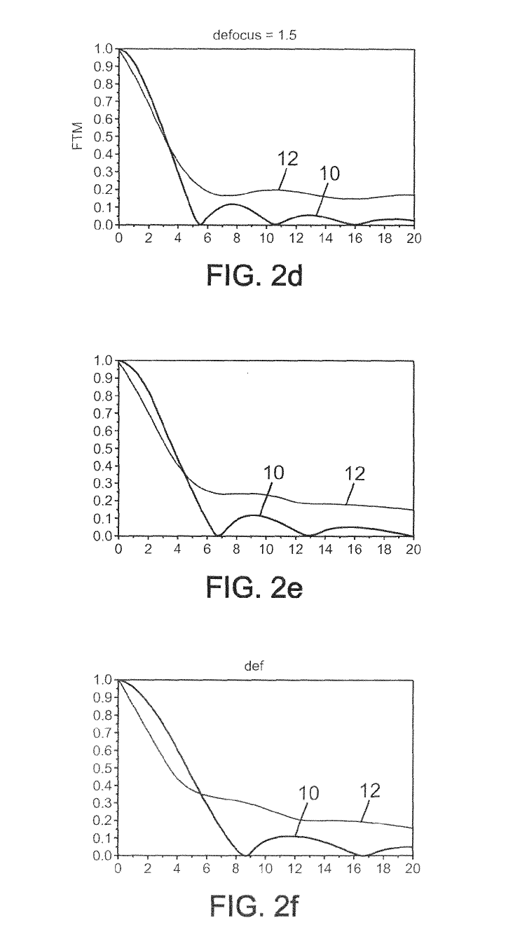

FIGS. 2a to 2f represent modulation transfer functions 10 of far vision corrected eye without phase modulation mask and modulation transfer functions 12 of far vision corrected eye with phase modulation mask according to the invention. As already explained, the relevant extended depth of focus described here above may be obtained by adding, at least in the near vision zone of a progressive addition lens according to the invention, a phase modulation mask that presents said modulation transfer function 12.

The progressive addition lens according to the invention has an addition value of 1 diopter.

The modulation transfer functions are measured for a pupil diameter of 4 mm and over a range of spatial frequency comprised between 0 and 20 cycles per degree.

FIGS. 2a to 2f represent the modulation transfer functions measured in plans situated at different distances. For each figure, the modulation transfer function (MTF) is measured at a specific viewing distance, which is not the same from a figure to another one.

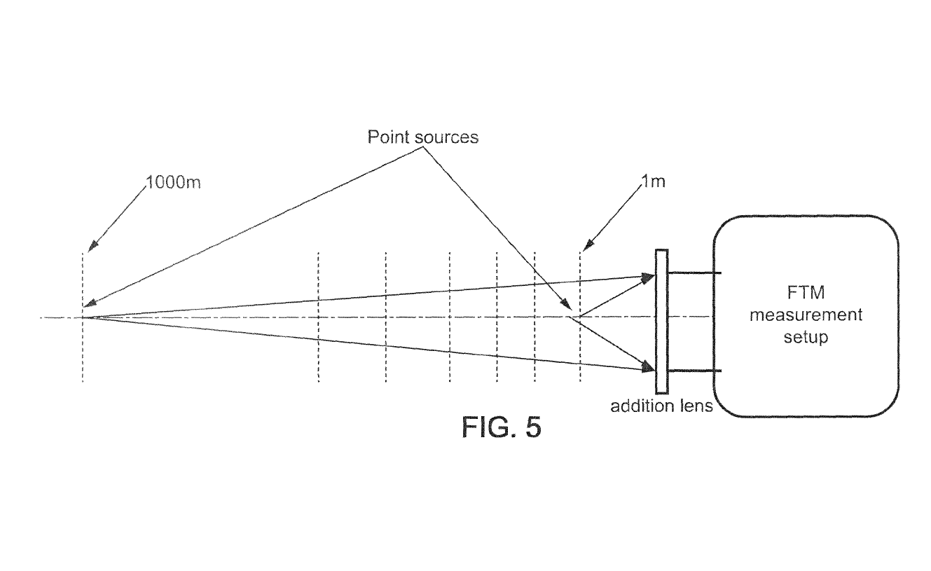

FIG. 5 is a general scheme showing how the MTF is measured through the lens.

Said measurement is centered on a same viewing direction.

N measurements are made for N distances, each distance being taken between the addition lens and a plane located at said distance. A distance of 1000 m represents infinite, a distance of 1 m represents an optical power of 1 diopter.

More precisely:

FIG. 2a is the modulation transfer functions measured at 1000 m.

FIG. 2b is the modulation transfer functions measured at 5 m.

FIG. 2c is the modulation transfer functions measured at 2 m.

FIG. 2d is the modulation transfer functions measured at 1.5 m.

FIG. 2e is the modulation transfer functions measured at 1.2 m.

FIG. 2f is the modulation transfer functions measured at 1 m.

As illustrated in FIGS. 2a to 2f, curve 10 represents the modulation transfer function for one far vision corrected eye without phase modulation mask.

As illustrated in FIGS. 2a to 2f, curve 12 represents the modulation transfer function for one far vision corrected eye with a phase modulation mask used in a progressive addition lens according to the invention.

As illustrated by FIGS. 2a to 2f, the modulation transfer function 12 of the lens with a phase modulation mask according to the invention does not drop below 0.1. In fact, the inventors have measured that the lower value of modulation transfer function for the lens with a phase modulation mask according to the invention is 0.123.

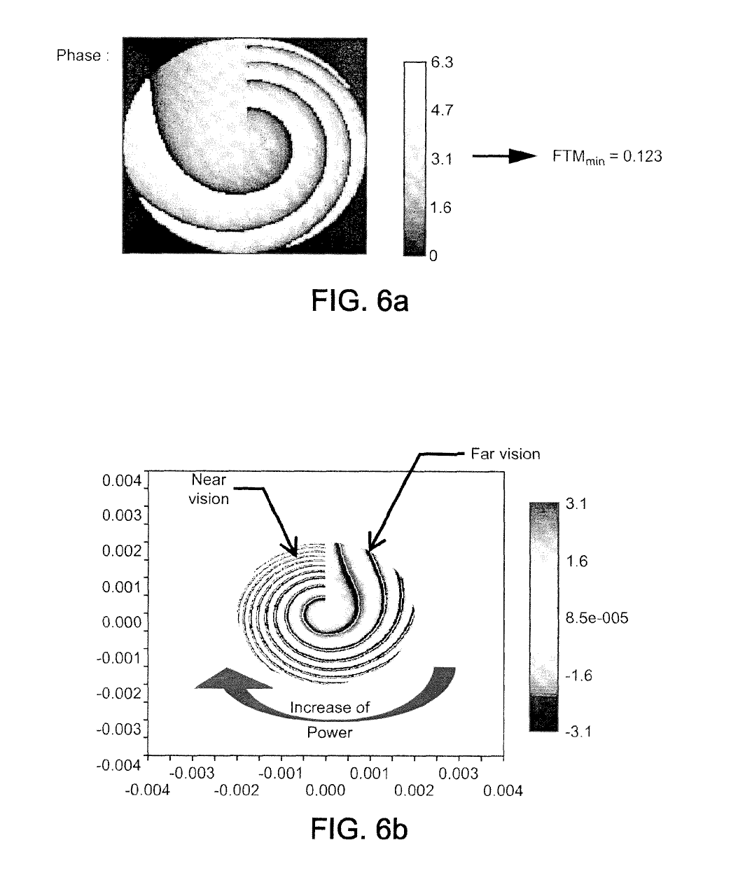

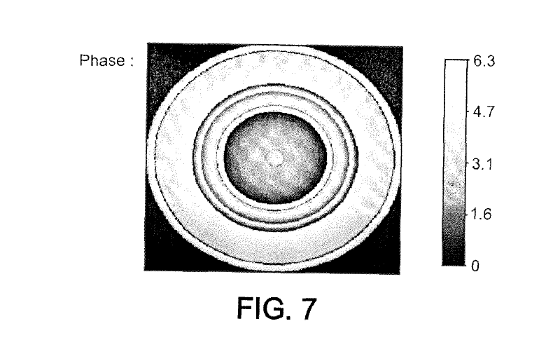

Such a value of 0.123 may for instance be obtained with a phase modulation mask as, centered on the near vision zone, shown in FIG. 6 (“snail” shape) or in FIG. 7 (“concentric” shape). It may also be obtained with geometrical aberrations, at least on one of the surfaces of the near vision zone, with spherical shapes.

Whereas the modulation transfer function 10 of the prior art lens drops at zero for plan between 2 m and 1 m. In other words, the wearer can not distinct two lines of a grid pattern of alternate black and white lines when the grid is situated between 1 m and 2 m for a spatial frequency of the grid greater than about 6 cycles per degree.

Finally, as illustrated when comparing FIGS. 2a to 2f it appears that although the modulation transfer functions of the lens with a phase modulation mask according to the invention are lower than the modulation transfer function of a far vision corrected eye without phase modulation mask

at distance larger than 5 m, at close distances, i.e. below 2 m, the modulation transfer functions 12 of the lens according to the invention is greater than the one of a far vision corrected eye without phase modulation mask.

Overall the progressive addition lens according to the invention presents less unintentional astigmatism, due to the lower addition value, and allows the wearer to see clearly, for example, at any distance between 0.5 m and 1000 m.

In particular, FIG. 2f represents the case where the viewing distance is of 0.5 m. It corresponds to an ophtalmologist's prescription of 2 diopters for the addition. In that case, the near vision zone of the lens according to the invention may be of 1 diopter (1 m), without taking into account the phase modulation mask. Then, we need 1 diopter to come to the 2 diopters prescribed by the ophthalmologist. Consequently, the extended depth of focus is of 0.5 m (1 m −0.5 m.

In another example, if the ophtalmologist's prescription indicates an addition value of 1.5 diopter (0.66 m), the near vision zone of the progressive addition lens according to the invention will for example provide an addition value of 1 diopter (1 m), without taking into account the mask. To obtain the remaining 0.5 diopter (extended focus of 1 m-0.66 m=0.33 m) necessary to come to the addition of 1.5 diopter prescribed by the ophthalmologist, a phase modulation mask is provided. In this example, the extended depth of focus is of 0.33 m. The wearer may then see clearly between 0.66 m (no figure is represented for this distance of 0.66 m as FIGS. 2a to 2f are given for distances comprised between 0.5 m and 1000 m). Less astigmatism is obtained thanks to the reduced addition value of the near vision zone.

According to another example, if the ophtalmologist's prescription indicates an addition value of 2.5 diopter (0.4 m), the near vision zone of the progressive addition lens according to the invention will for example provide an addition value of 2 diopters (0.5 m). To obtain the remaining 0.5 diopter (extended focus of 0.5 m−0.4 m=0.1 m) necessary to come to the addition of 2.5 diopter prescribed by the ophthalmologist, a phase modulation mask with the properties mentioned in FIGS. 2a to 2f is provided. Such an example corresponds to an extended depth of focus of 0.1 m. The wearer may then see clearly between 0.4 m and 1000 m. Less astigmatism is obtained thanks to the reduced addition value of the near vision zone.

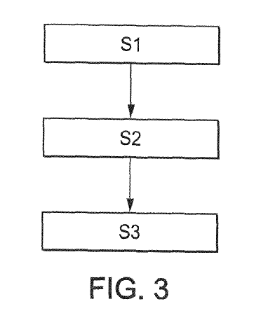

As illustrated on FIG. 3, the invention further relates to a process implemented by computer means for determining the optical surfaces of a progressive addition lens for a wearer, the method comprising:
a prescription data providing step S1,
an optical function determining S2, and
a surface determining step S3,

During the prescription data providing step S1, prescription data of the wearer comprising the prescribed addition are provided.

During the optical function determining step S2 an optical function according to the prescription data is determined.

The optical function corresponds to a virtual progressive lens having:
a first vision zone corresponding to the portion of the progressive addition lens having the dioptric power for the first distance vision corresponding to the prescription data,
an addition between the first vision zone and the near vision smaller in absolute value than the addition of the prescription data, and
for a pupil diameter of 4 mm the modulation transfer function differs from zero over the range of spatial frequency comprised between 0 and 20 cycles per degree.

According to an embodiment of the invention, during the optical function determining step, geometrical aberrations are added to the virtual progressive lens so as to increase the depth of focus in the near vision zone.

According to an embodiment of the invention, the process further comprises a phase modulation mask determining step.

During this phase modulation mask determining step a phase modulation mask to be added at least in the near vision zone of optical lens so as to increase the depth of focus in the near vision zone is determined.

During the surface determining step S3 the surfaces of an optical lens having the previously determined optical function are determined.

The progressive addition lens according to the invention can be manufactured according to a manufacturing process using a manufacturing device comprising the steps of:
providing a lens blank,
blocking the lens blank,
surfacing the surfaces of the lens blank as determined according to the process of the invention.

Many further modifications and variations will suggest themselves to those versed in the art upon making reference to the foregoing illustrative embodiments, which are given by way of example only and which are not intended to limit the scope of the invention, that being determined solely by the appended claims.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used. Any reference signs in the claims should not be construed as limiting the scope of the invention.

1. A progressive addition lens for a wearer, the optical lens having an addition lower by at least 0.5 diopter to the prescribed addition value of the wearer, wherein for a pupil diameter of at least 4 mm the modulation transfer function is greater or equal to 0.1 over the range of spatial frequency comprised between 0 and 20 cycles per degree.

2. The progressive addition lens according to claim 1, wherein the addition of the optical lens is lower by at least 1 diopter to the prescribed addition of the wearer.

3. The progressive addition lens according to claim 1, wherein the progressive addition lens comprises at least in the near vision zone a phase modulation mask configured for effecting a modulation of the light.

4. The progressive addition lens according to claim 3, wherein the phase modulation mask is configured so as to provide optical power.

5. The progressive addition lens according to claim 1, wherein at least one of the surfaces of the progressive addition lens comprises geometrical aberrations.

6. The progressive addition lens according to claim 1 comprising:
a first vision zone corresponding to the portion of the progressive addition lens having a dioptric power for a first distance vision,
a near vision zone corresponding to the portion of the progressive addition lens for near distance vision,
a intermediate corridor corresponding to the portion of the progressive addition lens providing clear vision for ranges intermediates between the first distance and the near distance,
wherein the first vision zone is a far vision zone or an intermediate vision zone.

7. A process implemented by computer means for determining the optical surfaces of a progressive addition lens for a wearer, the process comprising:
a prescription data providing step during which prescription data of the wearer comprising the prescribed addition are provided;
an optical function determining step during which an optical function according to the prescription data is determined; and
a surface determining step during which the surfaces of an optical lens having the previously determined optical function are determined;
wherein the optical function corresponds to a virtual progressive lens having:
a first vision zone corresponding to the portion of the progressive addition lens having the dioptric power for the first distance vision corresponding to the prescription data,
an addition between the first vision zone and the near vision smaller in absolute value than the addition of the prescription data, and
wherein for a pupil diameter of 4 mm the modulation transfer function is greater or equal to 0.1 over the range of spatial frequency comprised between 0 and 20 cycles per degree.

8. The process according to claim 7, wherein during the optical function determining step, geometrical aberrations are added to the virtual progressive lens so as to increase the depth of focus in the near vision zone.

9. The process according to claim 7, wherein the process further comprises a phase modulation mask determining step during which a phase modulation mask to be added at least in the near vision zone of optical lens so as to increase the depth of focus in the near vision zone is determined.

10. A process for manufacturing a progressive addition lens using a manufacturing device comprising the steps of:
providing a lens blank;
blocking the lens blank; and
surfacing the surfaces of the lens blank as determined according to a process implemented by computer means for determining the optical surfaces of a progressive addition lens for a wearer, the process comprising:
a prescription data providing step during which prescription data of the wearer comprising the prescribed addition are provided,
an optical function determining step during which an optical function according to the prescription data is determined, and
a surface determining step during which the surfaces of an optical lens having the previously determined optical function are determined,
wherein the optical function corresponds to a virtual progressive lens having:
a first vision zone corresponding to the portion of the progressive addition lens having the dioptric power for the first distance vision corresponding to the prescription data,
an addition between the first vision zone and the near vision smaller in absolute value than the addition of the prescription data, and
wherein for a pupil diameter of 4 mm the modulation transfer function is greater or equal to 0.1 over the range of spatial frequency comprised between 0 and 20 cycles per degree.

11. A computer program product for a data-processing device, the computer program product comprising a set of instructions which, when loaded into the data-processing device, causes the device to perform the steps of the processes as claimed in claim 7.

12. A computer-readable medium carrying the sequences of instructions of the computer program product of claim 11.
